(19) United States
(12) Patent Application Publication
(10) Pub. No.: US 2009/0169788 A1
(43) Pub. Date: Jul. 2, 2009

(54) Impervious, chemically stable thermoplastic tubing and film

(75) Inventors: Raj N. Pandey, Guelph (CA); Rupesh N. Pandey, Guelph (CA); Terry L. Jackson, Salem (CA)

Correspondence Address: BUCHANAN, INGERSOLL & ROONEY PC, POST OFFICE BOX 1404, ALEXANDRIA, VA, 22313-1404, US

(73) Assignee: Raj N. Pandey, Guelph (CA)

(21) Appl. No.: 12/285,954

(22) Filed: Oct. 16, 2008

Related U.S. Application Data
(63) Continuation of application No. 11/509,583, filed on Aug. 25, 2006, now abandoned.
Application No. 11/509,583 is a continuation of application No. 10/631,709, filed on Aug. 1, 2003, now abandoned.
Application No. 10/631,709 is a continuation-in-part of application No. 09/444,866, filed on Nov. 22, 1999, now abandoned.

(51) Int. Cl. F16L 11/04

(52) U.S. Cl. 428/36.91

(57) ABSTRACT

A layered tubing for conveying a non-toxic fluid comprises an inner layer having an inner surface adapted for exposure to the fluid, the inner layer consisting essentially of a polyester comprising units of the formula C₁₀H₈O₄, and an outer layer comprising a thermoplastic polymer, the outer layer being bonded either directly or indirectly to the inner layer. Such a tubing is useful for conveying non-toxic fluids such as water, syrups and beverages. The polyester can also be used in the form of a film for packaging solids suitable for human consumption, such as food and medicaments.

This application is a continuation of U.S. Ser. No. 10/631,709 filed Aug. 1, 2003 that is a continuation-in-part of U.S. Ser. No. 09/444,866, filed Nov. 22, 1999.

### FIELD OF THE INVENTION

The present invention pertains to improvements in the field of thermoplastic tubing and film. More particularly, the invention relates to a substantially impervious, chemically stable thermoplastic tubing for conveying non-toxic fluids such as water, syrups and beverages. The invention also relates to a substantially impervious, chemically stable thermoplastic film for packaging is solids for human consumption, such as food and medicaments.

### BACKGROUND OF THE INVENTION

Thermoplastic tubing used in the beverage industry must be impermeable so as not to cause contamination or become contaminated when in close proximity with other liquids or beverages. For example, the tubing used for conveying syrups or carbonated beverages must not impart taste or odor to the syrup or beverage and must not be susceptible to stress cracking. The tubing must be chemically stable and thus must not contribute any possible inorganic or organic contaminant to the beverage contained therein or flowing through it. If for example, water meeting the drinking water criteria of U.S. Environmental Protection Agency (U.S. E.P.A.) or the Drinking Water Objectives of Ontario, Canada, is passed through the tubing, the test results before passing and after should be the same.

Unfortunately, the plastic tubes currently used suffer from self and cross contamination problems mainly due to permeability and diffusion properties which may alter the taste, create odors and sometimes after long term exposure may pose a safety problem to human health. Other problems are related to carbonated beverages in which dissolved carbon dioxide is found to permeate through the tubing, resulting in a lowering of the carbon dioxide content in the beverage. Moreover, the tubes used nowadays are permeable to oxygen which causes the oxidation of some ingredients present in the beverage. Such an oxidation thereby generates alteration of the taste and a loss of the freshness of the beverage. The same oxygen permeation problem is also to encountered with some currently used film for packaging solids for human consumption.

The phenomena of environmental problems which in recent years have received prominent recognition worldwide, including Canada and the is United States, pertain to health. The scrutiny is related to the diffusion of volatile organics (C₁ to C₁₀ hydrocarbons) from the tube composed of thermoplastic polymeric material to the liquid it contains. These organics which are formed during the manufacture of the thermoplastic tube and become trapped in the polymer matrix may or may not contribute to taste and odor problems and therefore may not be perceived by human sensory mechanisms.

In carefully designed experiments, gas chromatography/mass spectrometry (GC/MS) analysis performed on air samples collected by evacuation or pressure differential techniques from many tubes currently used in the beverage industry, has detected presence of hydrocarbons. When the empty tubes were purged with inert gases such as helium or nitrogen and the stream analyzed by the techniques of GC/MS, hydrocarbons were found in the stream. When a typical tube was filled with pure distilled water and allowed to stand at room temperature, and the water was analyzed by the techniques of GC/MS, hydrocarbons were often detected. The source of these hydrocarbons is related to the polymeric thermoplastic material itself and they are most likely formed during the heating and melting of the polymer in the extrusion of the tubing, and remained captured during and after cooling. The volatile organic materials formed in the molten state of the polymer resin and held trapped in the polymer matrix are capable of diffusing through the inner surface of the tubing and contaminate the beverages contained therein. This phenomenon is found with most tubing manufactured today from polyethylene and related materials. With the exception of these drawbacks, polyethylene and related materials are low cost materials which meet various other attributes of the tubing materials such as shrinkage, elongation, stress-crack resistance and flexibility, and therefore have been predominantly marketed as economical tubing.

It is becoming increasingly important that the tubing employed for conveying and dispensing beverages be impervious to interaction with the flavoring agents present in the beverages, such as methyl salicylate which is the flavoring agent for root beer. Additionally, the tube must be fully inert when in contact with chlorinated city water and cleaning solutions such as DIVERSOL (trademark). It is also imperative that the tube employed for conveying and dispensing beverages be substantially impervious to hydrocarbon contamination due mainly to permeation and diffusion through the tubing.

In recent years, considerable attention has been given to solving the permeation problem. Various types of tubing have been proposed and used to address this problem, but with partial success. Tubing made of materials such as fluorocarbon, nylon, polypropylene, etc. have added improvements and have shown a performance advantage with regards to the transmission and diffusion of flavors; however, there is a loss in the flexibility of the tubing. Additionally, the cost of some constructions may be four times higher than the polyethylene products. Furthermore, fluorocarbons have high softening points making it difficult to extrude in an energy efficient manner. Although they are very strong, translucent fluorine-containing polymers always carry a potential concern of forming corrosive HF gas in a molten condition during the extrusion process while in contact with the polymers such as polyethylene, containing carbon and hydrogen in their molecules.

Most recently, with the introduction of many new pungent flavors, it has become increasingly difficult to flush out a tube in order to change beverage flavors in a dispenser system. With the more pungent flavors such as root beer and cherry, it is virtually impossible to remove the absorbed flavor from current state-of-the-art tubes.

### SUMMARY OF THE INVENTION

It is therefore an object of the present invention to overcome the above-mentioned drawbacks.

According to one aspect of the invention, there is provided a two-layer tubing for conveying a non-toxic fluid, comprising:

an inner layer having a fluid contacting surface, the inner layer consisting essentially of a polyester comprising units of the formula C₁₀H₈O₄; and

an outer layer comprising a blend of a thermoplastic polymer and a polymeric bonding agent with the thermoplastic polymer being present in a major portion and the polymeric bonding agent in a minor portion, the outer layer being bonded directly to the inner layer.

According to another aspect of the invention, there is provided a three-layer tubing for conveying a non-toxic fluid, comprising:

an inner layer having a fluid contacting surface, the inner layer consisting essentially of the aforesaid polyester;

an outer layer disposed about the inner layer and comprising a thermoplastic polymer; and

a bonding layer disposed between the inner and outer layers and comprising a polymeric bonding agent bonding the inner and outer layers together.

According to a further aspect of the invention, there is provided a four-layer tubing for conveying a non-toxic fluid, comprising:

an inner layer having a fluid contacting surface, the inner layer consisting essentially of the aforesaid polyester;

an outer layer disposed about the inner layer and comprising a blend of a thermoplastic polymer and a first polymeric bonding agent with the thermoplastic polymer being present in a major portion and the polymeric bonding agent in a minor portion;

an intermediate layer composed of ethylene vinyl alcohol and disposed between the inner and outer layers with the outer layer being bonded directly to the intermediate layer; and

a bonding layer disposed between the inner and intermediate layers and comprising a second polymeric bonding agent bonding the Inner and intermediate layers together.

According to yet another aspect of the invention, there is provided a five-layer tubing for conveying a non-toxic fluid, comprising:

an inner layer having a fluid contacting surface, the inner layer consisting essentially of the aforesaid polyester;

an outer layer disposed about the inner layer and comprising a thermoplastic polymer;

an intermediate layer composed of ethylene vinyl alcohol and disposed between the inner and outer layers;

a first bonding layer disposed between the inner and intermediate layers and comprising a first polymeric bonding agent bonding the inner and intermediate layers together; and

a second bonding layer disposed between the intermediate and outer layers and comprising a second polymeric bonding agent bonding the intermediate and outer layers together.

Applicant has found quite unexpectedly that in either the two-, three, four- or five-layer tubing of the invention, the inner layer composed of the aforesaid polyester acts as a barrier preventing contaminants from passing from the outer layer into the fluid and further preventing ingredients optionally present in the fluid from passing therefrom to the outer layer. In particular, the inner layer is substantially impervious to CO₂ and O₂. The tubings of the invention are thus efficient to maintain the freshness of a liquid, preferably a carbonated beverage, by preventing the CO₂ from escaping from the beverage. The tubings are also efficient to maintain the freshness and the taste of a liquid by preventing O₂ from oxidizing any oxidizable ingredient potentially present in the liquid. Such a barrier layer is not only substantially impervious to vapors and gases, but is also chemically stable since it does not contribute any contaminant to the fluid.

Applicant has also found quite unexpectedly that the aforesaid polyester can be used in the form of a film for packaging solids suitable for human consumption, such as food and medicaments. Such a film can be a single-layer or three-layer film. The above-mentioned film is also efficient to maintain the freshness and the taste of solids suitable for human consumption by preventing O₂ from oxidizing any oxidizable ingredient potentially present in such solids.

The present invention therefore provides, in a further aspect thereof, a film for packaging solids suitable for human consumption and consisting essentially of the aforesaid polyester. Since such a polyester is thermoplastic, the film can be produced by extrusion.

According to yet another aspect of the invention, there is provided a three-layer film for packaging solids suitable for human consumption, comprising:

a first layer consisting essentially of the aforesaid polyester, the first layer having first and second surfaces facing away from one another with the first surface defining a solids contacting surface;

a second layer comprising a thermoplastic polymer; and

an intermediate bonding layer disposed between the first and second layers and comprising a polymeric bonding agent bonding the second layer to the second surface of the first layer.

### DETAILED DESCRIPTION OF THE INVENTION

The formula C₁₀H₈O₄ for the units present in the polyester used in accordance with the invention has been determined by elemental analysis. The polyester can have a CO₂ permeability of less than 100, preferably less than 50 and more preferably of about 28 cm³·mm/m²·24 h·atm. The polyester can also have a O₂ permeability of less than 50, preferably less than 10 and more preferably of about 5.1 cm³·mm/m²·24 h·atm. The polyester can further have a water vapor transmission rate of less than 25, preferably less than 10 and more preferably of about 6.0 g/m²·24 h. The polyester preferably has a melting point less than 260° C. More preferably, the polyester has a melting point of about 245° C. and a density between 1.1 and 1.4 g/ml.

The particularly preferred polyester is available from the Eastman Chemical Company under the trademark EASTAPAK Polymer 9921 or under its equivalent, the trademark VORIDIAN PET 9921W, Voridian being an operating division of Eastman. This polyester has a CO₂ permeability of 28 cm³·mm/m²·24 h·atm, an O₂ permeability of 5.1 cm³·mm/m²·24 h·atm and a water vapor transmission rate of 6.0 g/m²·24 h. This polyester has a carbon content (% C) of 62.44%, a hydrogen content (% H) of 4.16% and an oxygen content (% O) of 33.46%, determined experimentally. The other characteristic of this polyester are listed in the EASTAPAK Polymer 9921 Product Data Sheet and in the VORIDIAN PET 9921W Product Data Sheet, which are hereby incorporated by reference.

Another preferred polyester is available from the Eastman Chemical Company under the trademark EASTAR PETG Copolyester 6763. This polyester has a CO₂ permeability of 49 cm³·mm/m²·24 h·atm, an O₂ permeability of 10 cm³·mm/m²·24 h·atm and a water vapor transmission rate of 6 g/m²·24 h. The other characteristic of this polyester are listed in the EASTAR PETG Copolyester 6763 Product Data Sheet, which is hereby incorporated by reference.

Examples of suitable thermoplastic polymers include low density or high density polyethylene, polypropylene, ethylene vinyl acetate and polyvinyl chloride. Polyethylene having a melting point of about 180° C. is preferably used.

Where the thermoplastic polymer used in the two- or three-layer tubing or three-layer film of the invention is polyethylene, the polymeric bonding agent used is preferably a polymer comprising units of the formula C₈H₁₈O (determined by elemental analysis). A particularly preferred bonding polymer is one having a melting point of about 55° C. and a density of about 0.9 g/ml. Such a bonding polymer is available from Elf Atochem under the trademark LOTADER. This polymer has a carbon content (% C) of 75.03%, a hydrogen content (% H) of 12.60% and an oxygen content (% O) of 12.48%, determined experimentally. It is also possible to use a polymeric bonding agent comprising a copolymer of ethylene and an oxygen-containing olefin. A particularly preferred bonding copolymer is one having a melting point in the range of 104-138° C. and a specific gravity between 0.89 and 0.95. Such a bonding copolymer is available from Equistar Chemicals under the trademark PLEXAR. This copolymer has a carbon content (% C) of 79.2%, a hydrogen content (% H) of 13.6% and an oxygen content (% O) of 7.6%, determined experimentally.

According to a preferred embodiment, the outer layer of the two-layer tubing comprises about 80 weight % of the thermoplastic polymer and about 20 weight % of the polymeric bonding agent.

According to another preferred embodiment, the fluid contacting surface of the inner layer of any tubings of this invention is uniform and substantially defect-free.

The expression “substantially defect-free” as used herein refers to a fluid contacting surface which does not have any substantial defect that will diminish its properties.

Advantageously, said fluid contacting surface of the inner layer presents smoothness and perfectness characteristics that may further improve its non permeability by reducing the risk of fluid turbulence that could lead to foaming.

An intermediate layer composed of ethylene vinyl alcohol is used in both the four-layer tubing and the five-layer tubing according to the invention. Ethylene vinyl alcohol has excellent vapor and gas barrier properties when in a dry state, such as when protected from moisture by a coextruded layer of polyolefin. Where the thermoplastic polymer used is polyethylene, the first polymeric bonding agent in the four-layer tubing and the second polymeric bonding agent in the five-layer tubing preferably comprise a maleic anhydride modified polyolefin. A particularly preferred bonding polyolefin is one having a melting point of about 127° C. and a specific gravity of about 0.9. Such a bonding is polyolefin is available from Morton International Inc. under the trademark TYMOR. This modified polyolefin has a carbon content (% C) of 84.7%, a hydrogen content (% H) of 15.3% and an oxygen content (% O) of 1.2%, determined experimentally. The second polymeric bonding agent in the four-layer tubing and the first polymeric bonding agent in the five-layer tube, on the other hand, preferably comprise a copolymer of ethylene and an oxygen-containing olefin. A particularly preferred bonding copolymer is one having a melting point between 104 and 138° C. and a specific gravity between 0.89 and 0.95. As previously indicated, such a bonding copolymer is available from Equistar Chemicals under the trademark PLEXAR.

According to a preferred embodiment, the outer layer of the four-layer tubing comprises about 80 weight % of the thermoplastic polymer and about 20 weight % of the first polymeric bonding agent.

According to another preferred embodiment, the second bonding layer of the five-layer tubing comprises a blend of the second polymeric bonding agent and the thermoplastic polymer used in the outer layer. Use is preferably made of a blend comprising about 80 weight % of the thermoplastic polymer and about 20 weight % of the second polymeric bonding agent.

In some applications, for example in high-pressure environments, it may be desirable to have a tubing with greater pressure performance properties than normally achieved from the strength of the tubing materials alone. The addition of one or more reinforcement layers disposed about a layered tubing according to the invention can significantly increase the pressure performance and the resistance to bursting. Such reinforcement layer(s) can comprise several textile or metal strands applied in a spirally-wound, braided or knitted fashion. These reinforcement layers are generally protected and held in place by one or more outer layers or coatings of polymeric material.

The layered tubing according to the invention enables the flavor of beverages to be preserved. The film according to the Invention, on the other hand, enables the aroma, taste and moisture of food to be preserved. For example, the film of the invention can be used in the form of a bag for cereals and the like. It can also be used in the form of a cap liner or seal for sealing bottles containing medicaments.

### BRIEF DESCRIPTION OF THE DRAWINGS

Further features and advantages of the invention will become more readily apparent from the following description of preferred embodiments as illustrated by way of examples in the accompanying drawings, in which:

FIG. 1 is a cross-sectional view of a layered tubing according to a preferred embodiment of the invention;

FIG. 2 is a cross-sectional view of a layered tubing according to another preferred embodiment of the invention;

FIG. 3 is a cross-sectional view of a layered tubing according to a further preferred embodiment of the invention:

FIG. 4 is a cross-sectional view of a layered tubing according to yet another preferred embodiment of the invention;

FIG. 5 is a cross-sectional view of a layered tubing according to still a preferred embodiment of the invention;

FIG. 6 is a partial sectional view of a layered film according to preferred embodiment of the invention;

FIG. 7 is a schematic diagram of an experimental set-up used for performing flavor permeability studies on a tubing; and

FIG. 8 is another schematic diagram of an experimental set-up used for performing permeability studies on a film.

### DETAILED DESCRIPTION WITH REFERENCE TO DRAWINGS

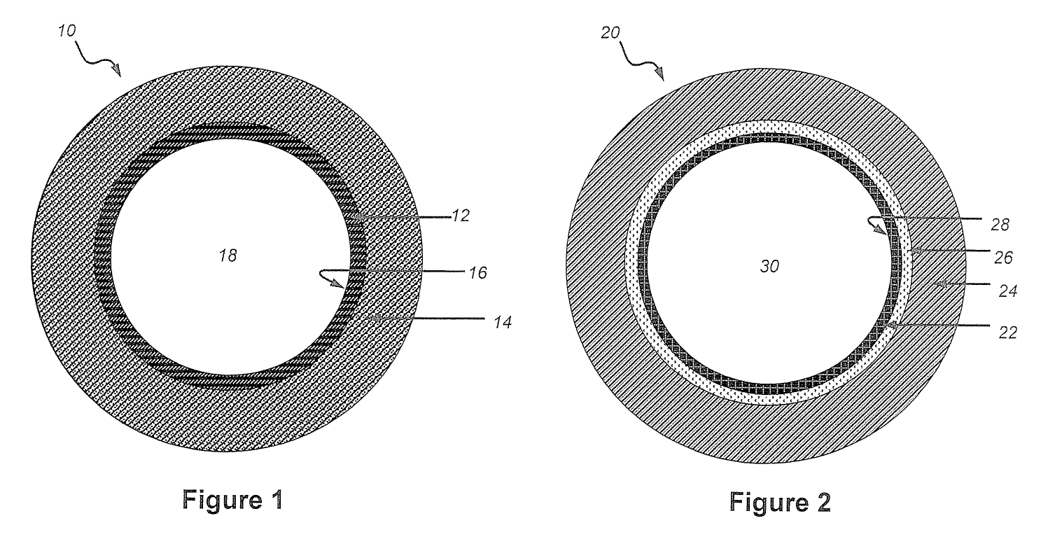

FIG. 1 illustrates a two-layer tubing 10 for conveying a non-toxic fluid. The tubing 10 comprises an inner layer 12 composed of a polyester sold under the trademark VORIDIAN PET 9921W and an outer layer 14 composed of a blend comprising about 80 weight % of polyethylene and about 20 weight % of a polymeric bonding agent sold under the trademark LOTADER or PLEXAR, the layer 14 being bonded directly to the layer 12. The latter layer has an inner surface 16 adapted for exposure to the fluid (not shown) flowing through the cavity 18 of the tubing. The layer 12 typically has a thickness of about 0.03 to about 0.1 mm, preferably about 0.05 mm. The layer 14, on the other hand, typically has a thickness of about 0.5 to about 2 mm, preferably about 1.4 mm.

The polyester layer 12 acts as a barrier preventing contaminants from passing from the layer 14 into the fluid and further preventing ingredients optionally present in the fluid from passing therefrom to the layer 14. The layer 12 is not only substantially impervious to vapors and gases, but is also chemically stable since it does not contribute any contaminant to the fluid.

FIG. 2 illustrates a three-layer tubing 20 for conveying a non-toxic fluid. The tubing 20 comprises an inner layer 22 composed of a polyester sold under the trademark VORIDIAN PET 9921W, an outer layer 24 disposed about the layer 22 and comprising polyethylene, and a bonding layer 26 disposed between the layers 22 and 24 and comprising a polymeric bonding agent sold under the trademark LOTADER or PLEXAR, which bonds the layers 22 and 24 together. The layer 22 has an Inner surface 28 adapted for exposure to the fluid (not shown) flowing through the cavity 30 of the tubing. The layer 22 typically has a thickness of about 0.03 to about 0.1 mm, preferably about 0.05 mm. The layer 24 typically has a thickness of about 0.5 to about 2 mm, preferably about 1.3 mm. The layer 26 typically has a thickness of about 0.05 to about 0.2 mm, preferably about 0.1 mm.

The polyester layer 22 acts as a barrier preventing contaminants from passing from the layer 24 into the fluid and further preventing ingredients optionally present in the fluid from passing therefrom to the layer 24. The layer 22 is not only substantially impervious to vapors and gases, but is also chemically stable since it does not contribute any contaminant to the fluid.

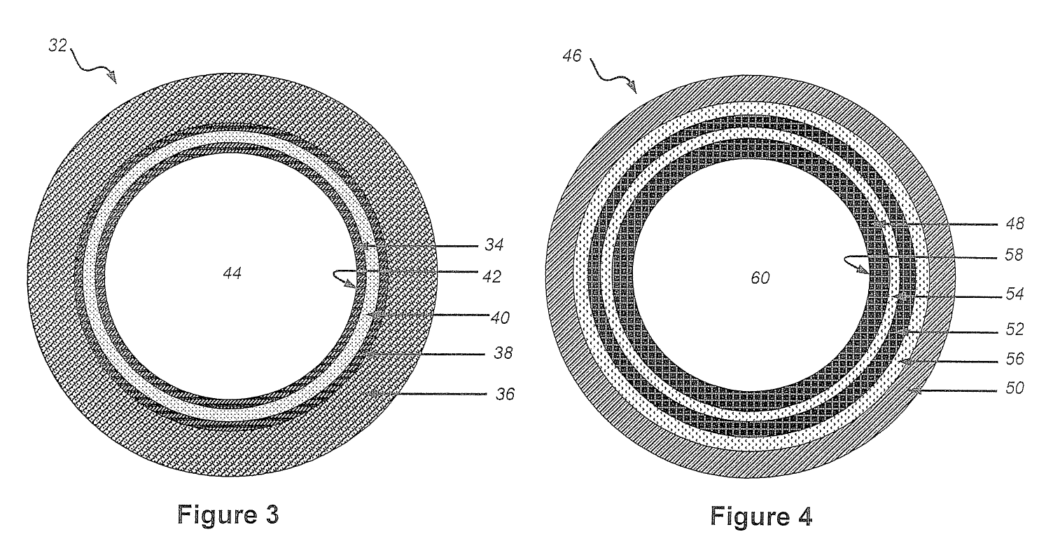

FIG. 3 illustrates a four-layer tubing 32 for conveying a non-toxic fluid. The tubing 32 comprises an inner layer 34 composed of a polyester sold under the trademark VORIDIAN PET 9921W, an outer layer 36 disposed about the layer 34 and composed of a blend comprising about 80 weight % of polyethylene and about 20 weight % of a polymeric bonding agent sold under the trademark TYMOR, an intermediate layer 38 composed of ethylene vinyl alcohol and disposed between the layers 34 and 36 with the layer 36 being bonded directly to the layer 38, and a bonding layer 40 disposed between the layers 34 and 38 and comprising a polymeric bonding agent sold under the trademark PLEXAR, which bonds the layers 34 and 38 together. The layer 34 has an inner surface 42 adapted for exposure to the fluid (not shown) flowing through the cavity 44 of the tubing. The layers 34 and 38 typically each have a thickness of about 0.03 to about 0.1 mm, preferably about 0.05 mm. The layer 36 typically has a thickness of about 0.5 to about 2 mm, preferably about 1.3 mm. The layer 40 typically has a thickness of about 0.05 to about 0.2 mm, preferably about 0.1 mm.

The polyester layer 34 acts as a barrier preventing contaminants from passing from the layer 36 into the fluid and further preventing ingredients optionally present in the fluid from passing therefrom to the layer 36. The layer 34 is not only substantially impervious to vapors and gases, but is also chemically stable since it does not contribute any contaminant to the fluid.

FIG. 4 illustrates a five-layer tubing 46 for conveying a non-toxic fluid. The tubing 46 comprises an inner layer 48 composed of a polyester sold under the trademark VORIDIAN PET 9921W, an outer layer 50 disposed about the layer 48 and comprising polyethylene, an intermediate layer 52 composed of ethylene vinyl alcohol and disposed between the layers 48 and 50, a bonding layer 54 disposed between the layers 48 and 52 and comprising a polymeric bonding agent sold under the trademark PLEXAR, which bonds the layers 48 and 52, and another bonding layer 56 disposed between the layers 50 and 52 and comprising a polymeric bonding agent sold under the trademark TYMOR, which bonds the layers 50 and 52 together. The layer 48 has an inner surface 58 adapted for exposure to the fluid (not shown) flowing through the cavity 60 of the tubing. The layers 48 and 52 typically each have a thickness of about 0.03 to about 0.1 mm, preferably about 0.05 mm. The layer 50 typically has a thickness of about 0.5 to about 2 mm, preferably about 1.2 mm. The layers 54 and 56 typically each have a thickness of about 0.05 to about 0.2 mm, preferably about 0.1 mm.

The polyester layer 48 acts as a barrier preventing contaminants from passing from the layer 50 into the fluid and further preventing ingredients optionally present in the fluid from passing therefrom to the layer 50. The layer 48 is not only substantially impervious to vapors and gases, but is also chemically stable since it does not contribute any contaminant to the fluid.

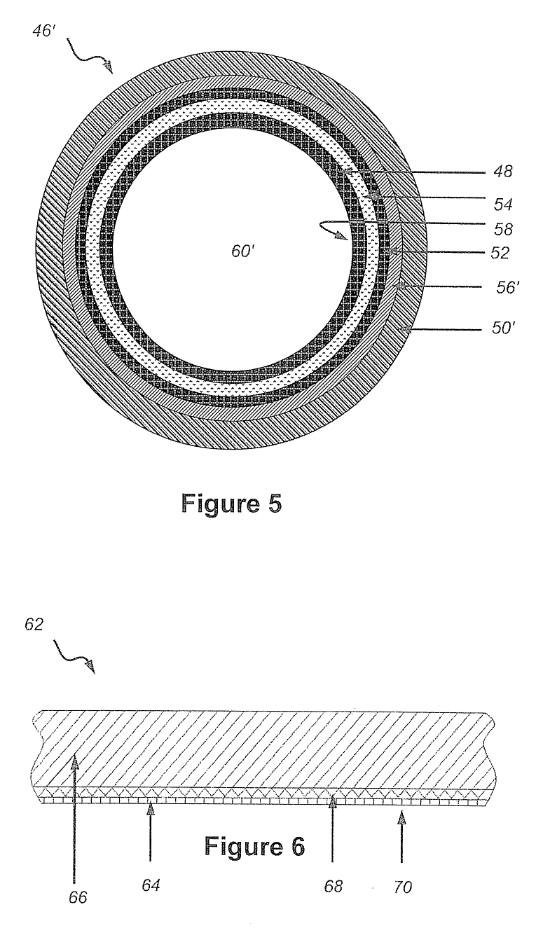

FIG. 5 illustrates a five-layer tubing 46′ which is similar to the tubing 46′ shown in FIG. 4, with the exception that the bonding layer 56′ is composed of a blend comprising about 80 weight % of polyethylene and about 0.20 weight % of TYMOR, and that the layers 50′ and 56′ of the tubing 46 have different thicknesses than the layers 50 and 56 of the tubing 46. The layer 50′ which is composed of polyethylene typically has a thickness of about 0.4 to about 2.0 mm, preferably about 0.9 mm. The layer 56′, on the other hand, typically has a thickness of about 0.4 to about 0.6 mm, preferably about 0.5 mm.

FIG. 6 illustrates a three-layer film 62 for packaging solids suitable for human consumption. The film 62 comprises a first layer 64 composed of a polyester sold under the trademark VORIDIAN PET 9921W, a second layer 66 comprising a thermoplastic polymer and an intermediate bonding layer 68 disposed between the layers 64 and 66 and comprising a polymeric bonding agent sold under the trademark LOTADER or PLEXAR, which bonds the layers 64 and 66 together. The layer 64 has a surface 70 adapted for exposure to the solids (not shown), the layer 66 acting as a liner. Thus, for example, when the film 62 is used in the form of a bag for cereals and the like, the surface 70 of the layer 64 faces the interior of the bag. When the film 62 is used in the form of a cap liner or seal for sealing bottles containing medicaments, the surface 70 faces the interior of the bottle. The layer 64 typically has a thickness of about 0.03 to about 0.1 mm, preferably about 0.05 mm. The layer 66 typically has a thickness of about 0.3 to about 2 mm, depending on the application. The layer 68 typically has a thickness of about 0.05 to about 0.2 mm, preferably about 0.1 mm.

The polyester layer 64 of the film 62 has the same barrier properties as the polyester layers 12, 22, 34 and 48 of the tubing 10, 20, 32 and 46, respectively.

The following non-limiting examples further illustrate the invention.

### Example 1

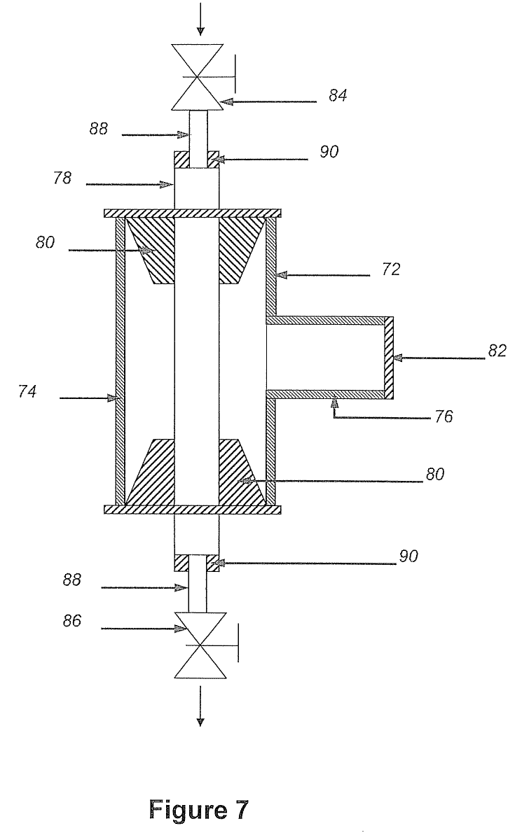

The barrier properties of a layered tubing comprising an inner layer composed of polyester sold under the trademark VORIDIAN PET 9921W were tested for flavor permeability in a specially designed experimental set-up which is illustrated in FIG. 7. As shown, use was made of a glass jacket 72 comprising ID a sleeve 74 and a tubular branch 76 extending laterally from the sleeve 74, the tubing 78 to be tested extending inside the sleeve 74 and through seal members 80 at the ends of the sleeve. The tubular branch 76 is provided with a septum 82 through which the needle of a sampling syringe can penetrate. The tubing 78 is connected at its ends to inlet and outlet valves 84,86 by conduits 88 extending through seal members 90.

The jacket 72 was filled with high purity water contacting the outer surface portion of the tubing 78 inside the sleeve 74. The tubing 78 was filled with root beer, by opening valve 84 and closing valve 86, and was allowed to stand for about 15 days at room temperature so as to saturate the Inner surface of the tubing 78 with root beer. Root beer contains about 150 ppm of methyl salicylate as flavoring agent. The detection of methyl salicylate in the permeant was used for the measurement of permeation.

The components of root beer permeating through the wall of the tubing 78 were allowed to collect in the water surrounding the tubing 78. Samples of water were withdrawn by means of a syringe (not shown) and analyzed for the presence of the permeant by the technique of GC/MS using purge and trap. The flavor permeability study was performed using as test tubing the layered tubing 10, 20, 32, 46 and 46′. A comparative study was also performed using as test tubing 78 a polyethylene tubing. The results are shown in Table 1.

TABLE 1

| Tubing Tested | Saturation Period | Methyl Salicylate | Permeation |
|---|---|---|---|
| Tubing 10, 20, | 15 days | Not Detected | No |
| 32, 46, 46′ | | | |
| Polyethylene | 15 days | Detected | Yes |
| Tubing | | (>10 ppm) | |

Detection Limit = <1 ppb

### Example 2

A layered tubing comprising an inner layer composed of polyester sold under the trademark VORIDIAN PET 9921W was filled with high purity water and was allowed to stand for 15 days. The water was then analyzed by Inductively Coupled Plasma for various metals. The objective was to determine if any metallic contaminants were present in the tubing since contamination may have occurred by the use of catalysts during the production of the polymeric materials. The results are shown in Table 2. These results indicate that the tubing does not contribute any metallic impurity to the water and that the water remains unaffected, thus meeting the drinking water objectives.

TABLE 2

| | | Water Sample from | |
|---|---|---|---|
| Parameter | High Purity Water | Inside of Tubing | MAC* |
| Tested | (mg/L) | (mg/L) | (mg/L) |
| Aluminum | N.D. | N.D. | 0.10 |
| Arsenic | N.D. | N.D. | 0.025 |
| Barium | 0.001 | 0.001 | 1.0 |
| Boron | 0.010 | 0.012 | 5.0 |
| Cadmium | N.D. | N.D. | 0.005 |
| Calcium | 0.14 | 0.10 | — |
| Chromium | N.D. | N.D. | 0.05 |
| Cobalt | N.D. | N.D. | — |
| Copper | N.D. | N.D. | 1.0 |
| Iron | 0.003 | 0.003 | 0.30 |
| Lead | N.D. | N.D. | 0.01 |
| Magnesium | 0.01 | 0.02 | — |
| Manganese | <0.005 | <0.005 | 0.05 |
| Mercury | <0.001 | <0.001 | 0.001 |
| Nickel | N.D. | N.D. | — |
| Selenium | N.D. | N.D. | 0.01 |
| Sodium | 0.15 | 0.12 | — |
| Vanadium | N.D. | N.D. | — |
| Zinc | <0.02 | <0.02 | 5.0 |

N.D. = Not Detected
Detection limit = 0.005 mg/L
Detection Limit for Mercury (Hg) = 0.001 mg/L
*MAC = Maximum Acceptable Concentration as a Drinking Water Objective - Health Related

### Example 3

High purity water was kept inside a layered tubing comprising an inner layer composed of polyester sold under the trademark VORIDIAN PET 9921W at room temperature for 10 days. The contained water was then scanned for possible organics by the technique of GC/MS using a Hewlett Packard GC/MS fitted with a Tekmar purge and trap. The results are shown in Table 3. These results further confirm, that the inner layer of the tubing, composed of VORIDIAN PET 9921W, does not contribute any organic volatile impurities to the water and that the water remains unaffected.

TABLE 3

| | | Water Sample | |
|---|---|---|---|
| | | from Inside of | Maximum Drinking |
| | Blank water | Tubing | Water Limit |
| Parameters | (mg/L) | (mg/L) | (mg/L) |
| Benzene | N.D. | N.D. | 0.005 |
| Toluene | N.D. | N.D. | 0.02 |
| Xylene | N.D. | N.D. | 0.30 |
| Ethyl Benzene | N.D. | N.D. | 0.002 |
| Volatile Organics | N.D. | N.D. | 0.01 |
| Trichloroethylene | N.D. | N.D. | 0.05 |
| Trihalomethane | N.D. | N.D. | 0.35 |
| Other Organics | N.D. | N.D. | |

N.D. = Not Detected (<0.001 mg/L)

### Example 4

Certain surfaces may contribute to microbial growth when in contact with beverages. A microbial growth test was carried out using a layered tubing comprising an inner layer composed of polyester sold under the trademark VORIDIAN PET 9921W. The study showed that the tubing does not contribute to microbial growth when exposed to 5% sugar solution at 23° C. for a period of seven days.

### Example 5

A single-layer film composed of polyester sold under the trademark VORIDIAN PET 9921W, having a thickness of about 0.1 mm to about 0.5 mm, was prepared in a laboratory, using a pair of dies comprising a bottom dies and top die placed in a gas chromatography oven. The polyester in pellet form was uniformly spread over the bottom die and the top dies placed on it. The die with the polyester therebetween were protected from air by flowing a pre-heated stream of nitrogen and purging the entire system of the oven. The temperature of the oven was programmed so as to increase linearly from room temperature to 320° C. at rate of 15° C. per minute. Once the temperature has reached about 270° C., the dies were taken out and pressed immediately to about 1000 psi or a pressure sufficient to obtain a film having the desired thickness. The dies were cooled in water and the film removed for testing.

Advantageously, the non-permeability property of an innermost polyester layer may further depend upon the smoothness and perfectness of its fluid contacting surface. Smooth fluid contacting surfaces reduce the beverage flow turbulance that could lead to foaming. As example, a fluid contacting surface, free from surface defect, was formed under the following process conditions. The VORIDIAN PET 9921W material was dried to a moisture level of less than 50 ppm before entering the extruder. This avoided the hydrolytic degradation and effects on intrinsic viscosity. The dried material was never allowed to be exposed to the atmosphere. The optimally non-permeable inner layer of polyester free from stiffness, odour, and colour were preferably formed by passing inert gases such as nitrogen which was passed through a filter to remove moisture and other impurities. The process thus created an inert atmosphere inside the tubing, preventing oxidation of the surface of polyester. An extended residence time in the extruder was as well used to achieve uniformly in the molten layer. The volatile components of the materials causing odours were removed via evacuation technique on the freshly formed tubing.

A group of five films produced by the above method were immersed in distilled water, the contents were boiled in a beaker for an hour, cooled to room temperature and the water with the films therein was kept for 7 days. The water was then analyzed by inductively Coupled Plasma for various metals. The anions were analyzed by a standard technique of Ion Chromatography. The results are shown in Table 5. These results indicate that the polyester film does not contribute any impurity to the water and that the water remains unaffected.

TABLE 5

| | Water Sample | |
|---|---|---|
| Parameter Tested | Analysis (mg/L) | MAC*(mg/L) |
| Aluminum | N.D. | 0.10 |
| Arsenic | N.D. | 0.025 |
| Barium | N.D. | 1.0 |
| Boron | N.D. | 5.0 |
| Cadmium | N.D. | 0.005 |
| Chromium | N.D. | 0.05 |
| Iron | N.D. | 0.30 |
| Nickel | N.D. | 0.01 |
| Lead | N.D. | 0.01 |
| Mercury | <0.001 | 0.001 |
| Manganese | N.D. | 0.05 |
| Selenium | N.D. | 0.01 |
| Uranium | N.D. | 0.10 |
| Nitrite (as N) | <0.1 | 1.0 |
| Nitrate (as N) | <0.1 | 10.0 |

N.D. = Not Detected
Detection limit = 0.005 mg/L
Detection limit for Mercury (Hg) = 0.001 mg/L
*MAC = Maximum Acceptable Concentration as a Drinking Water Objective - Health Related

### Example 6

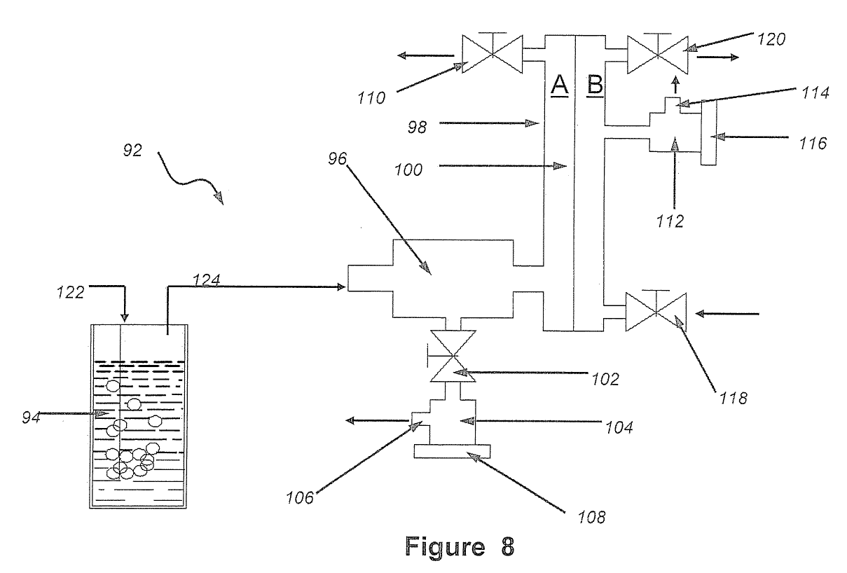

A single-layer film composed of polyester sold under the trademark VORIDIAN PET 9921W was subjected to a permeability test using a specially designed apparatus which is illustrated in FIG. 8. As shown, the apparatus which is generally designated by reference numeral 92 comprises a bubbler 94, a saturation chamber 96 in gas flow communication with the bubbler 94 and a permeation cell 98 in which is mounted the film 100 to be tested, the film 100 separating the cell chamber into compartments A and B with the compartment A being in gas flow communication with the saturation chamber 96. The latter chamber is in gas flow communication via valve 102 with a sampling chamber 104 having a gas outlet 106 which can be opened or closed and a septum 108 through which the needle of a sampling syringe can penetrate. An outlet valve 110 is connected to the cell 98, the valve 110 being in gas flow communication with the compartment A. Compartment B of the cell 98 is in gas flow communication with a sampling chamber 112 having a gas outlet 114 which can be opened or closed and a septum 116 through which the needle of a sampling syringe can penetrate. Inlet and outlet valves 118,120 are connected to the cell 98, the valves 118 and 120 being in gas flow communication with the compartment B.

An inert gas such as helium fed via line 122 was introduced into the bubbler 94 containing water so as to saturate the helium with water vapor. The water vapor-containing helium was withdrawn from the bubbler 94 and passed via line 124 to the saturation chamber 96, valve 102 being opened and valve 110 closed. The water vapor-containing helium was allowed to circulate through the chamber 96, valve 102 and sampling chamber 104 and to vent to the atmosphere through the gas outlet 106 until a steady state saturation was achieved in the chamber 96, which was determined by taking samples from the chamber 104 with a sampling syringe (not shown) and analyzing the samples by gas chromatography. Valve 102 was then closed and valve 110 opened to allow a continuous circulation of the water vapor saturated-helium through compartment A of the cell 98. Valves 118,120 and gas outlet 114 were opened to allow filling of compartment B and chamber 112 with dry helium, and thereafter closed. The film 100 was allowed to equilibrate with the water vapor in compartment A for at least 24 hours. Samples were periodically taken from the chamber 112 with a sampling syringe (not shown) and analyzed by gas chromatography. At the same time, valve 102 was opened to allow the taking of samples from chamber 104 in gas flow communication with compartment A. When the film 100 tested was a single-layer film composed of the aforesaid polyester, the presence of water vapor in compartment B of the cell 98 was not detected. Even after creating a differential pressure by lowering the pressure in compartment B, water vapor was still not detected in compartment B.

In further experiments, the helium was replaced by carbon dioxide and then by oxygen and the permeability tests were repeated, but without any liquid in the bubbler 94. Carbon dioxide and oxygen were not detected in compartment B of the cell 98. The results are summarized in Table 6. These results indicate that the polyester film is substantially impervious to water vapor, carbon dioxide and oxygen, in contrast to polyethylene films which were found to have a rapid permeation.

TABLE 6

| | | | Concentration | Concentration |
|---|---|---|---|---|
| | | | of Permeant in | of Permeant in |
| | Film | Temp. | Compartment | Compartment |
| Permeant | Tested | (° C.) | A | B |
| Water | VORIDIAN | 23-24 | Saturated | N.D. |
| | PET 9921W | | | |
| CO₂ | VORIDIAN | 23-24 | Saturated | N.D. |
| | PET 9921W | | | |
| O₂ | VORIDIAN | 23-24 | Saturated | N.D. |
| | PET 9921W | | | |

N.D. = Not detected

### Example 6A

In another experiment a single-layer film composed of polyester sold under the trademark EASTAR PETG Copolyester 6763 was subjected to a permeability test using the apparatus illustrated in FIG. 8. The testing procedure was the same as described in example 6. The results are presented in Table 6A.

TABLE 6A

| | | | Concentration | Concentration |
|---|---|---|---|---|
| | | | of Permeant in | of Permeant in |
| | Film | Temp. | Compartment | Compartment |
| Permeant | Tested | (° C.) | A | B |
| Water | EASTAR PETG | 23-24 | Saturated | N.D. |
| | Copolyester 6763 | | | |
| CO₂ | EASTAR PETG | 23-24 | Saturated | N.D. |
| | Copolyester 6763 | | | |
| O₂ | EASTAR PETG | 23-24 | Saturated | N.D. |
| | Copolyester 6763 | | | |

N.D. = Not detected

The final product of the novel layered tubing of this invention was found to possess superior barrier properties whether made with starting polyester such as VORIDIAN PET 9921W or EASTAR PETG Copolyester 6763. In view of these results, it can be assumed that the fluid contacting surface of the inner layer of these tubings is uniform and substantially defect-free.

### Example 7

Permeability studies were carried out using the apparatus 92 shown in FIG. 8, by successively filling the bubbler 94 with alcohol, acetone and pentane. The concentration of the permeant was measured by gas chromatography. A comparative study was also performed using a polyethylene film. The results are shown in Table 7. These results clearly indicate that the polyester film does not allow permeation of organic volatiles.

TABLE 7

| | | | Concentration | Concentration |
|---|---|---|---|---|
| | | Temp. | of Permeant in | of Permeant in |
| | Film | (° C.) | Compartment | Compartment |
| Permeant | Tested | ambient | A | B |
| Ethyl | Polyester | 23-24 | Steady State | N.D. |
| Alcohol | | | Saturation | |
| Acetone | Polyester | 23-24 | Steady State | N.D. |
| | | | Saturation | |
| Pentane | Polyester | 23-24 | Steady State | N.D. |
| | | | Saturation | |
| Pentane | Polyethylene | 23-24 | Steady State | Detected |
| | | | Saturation | |

N.D. = Not Detected

### Example 8

Permeability studies were carried out using the apparatus 92 shown in FIG. 8, by successively filling the bubbler 94 with two colas, root beer, beer and Scotch whisky. The results are shown in Table 8.

TABLE 8

| | | | Concentration | Concentration | |
|---|---|---|---|---|---|
| | | Temp | of Permeant in | of Permeant in | |
| Per- | Film | (° C.) | Compartment | Compartment | Permea- |
| meant | Tested | ambient | A | B | tion |
| Cola 1 | Polyester | 23-23 | Saturated | N.D. | None |
| Cola 2 | Polyester | 23-24 | Saturated | N.D. | None |
| Root | Polyester | 23-24 | Saturated | N.D. | None |
| Beer | | | | | |
| Beer | Polyester | 23-24 | Saturated | N.D. | None |
| Scotch | Polyester | 23-24 | Saturated | N.D. | None |
| Whisky | | | | | |

N.D. = Not Detected

### Example 9

A second batch of single-layer films composed of polyester sold under the trademark VORIDIAN PET 9921W were kept immersed in distilled water for a period of 2 weeks. The water was then analyzed for organic volatile impurities by the technique of GC/MS using a Hewlett Packard GC/MS with Tekmar purge and trap. The results are shown in Table 9. These results clearly indicate that the polyester film does not contribute any organic volatile impurities to the water and that the water remains unaffected.

TABLE 9

| | | Maximum Drinking |
|---|---|---|
| | Water Sample | Water Limit |
| Parameters | Analysis (mg/L) | Concentration (mg/L) |
| Benzene | N.D. | 0.005 |
| Toluene | N.D. | 0.02 |
| Xylene | N.D. | 0.30 |
| Ethyl Benzene | N.D. | 0.002 |
| Volatile Organics | N.D. | 0.01 |
| Trichloroethylene | N.D. | 0.05 |
| Trihalomethane | N.D. | 0.35 |

N.D. = Not Detected (<0.001 mg/L)

### Example 10

For application in beverage dispensing, the tubing used for dispensing the beverage must be washable or flushable with water. Single-layer films composed of polyester sold under the trademark VORIDIAN PET 9921W were soaked in two colas and in a beer for 24 hours at room temperature. The treated films were successively washed with distilled water. The wash solutions were collected and analyzed by GC/MS. 5 ml samples of each wash solution were introduced into a Tekmar purge and trap system and analyzed by a Hewlett-Packard GC/MS. The results are shown in Table 10. These results indicate that the film surface is flushable, implying that surface absorption is insignificant.

TABLE 10

| | Detection in Wash | | | | |
|---|---|---|---|---|---|
| | 1 | 2 | 3 | 4 | 5 |
| Cola 1 | Detected | Detected | N.D. | N.D. | N.D. |
| Cola 2 | Detected | Detected | N.D. | N.D. | N.D. |
| Beer | Detected | Detected | N.D. | N.D. | N.D. |

N.D. = Not Detected

### Example 11

Commercial tubing currently used for beverage dispensing was tested for the release of contaminating gases and vapors upon purging or creating a pressure differential by evacuation. A single-layer film composed of polyester sold under the trademark VORIDIAN PET 9921W was tested by evacuation only.

The experiment conducted on the commercial beverage dispensing tubing consisted in purging a certain length of tubing by passing a stream of helium through the tubing and analyzing the gases and vapors released by using a Hewlett Packard GC/MS. The results are shown in Table 11. These results indicate that the polyester film does not release any contaminant and is therefore environmentally safe.

TABLE 11

| | Test | Contaminants |
|---|---|---|
| Material Tested | Method | Found |
| Commercial tubing | Helium | C₇-C₁₀ |
| currently used for | Purge & Trap | Hydrocarbons |
| Beverage Dispensing | | |
| Commercial tubing | Evacuation | C₇-C₁₀ |
| currently used for | | Hydrocarbons |
| Beverage Dispensing | | |
| Polyester film | Evacuation | None |

Although the present invention has been described in connection with the preferred embodiments, it is to be understood that various changes and modifications may be made without departing from the principles and scope of the invention, as those skilled in the art will readily understand. Such changes and modifications may be practiced within the scope of the following claims.

1. A layered beverage tubing comprising:
an inner layer having a fluid contacting surface, said inner layer consisting essentially of a PET polyester comprising repeat units of the formula C₁₀H₈O₄, said polyester having a CO₂ permeability of less than 100 cm³·mm/m² 24 h·atm and an O₂ permeability of less than 50 cm³·mm/m² 24 h·atm; and
an outer layer comprising a blend of a thermoplastic polymer and a polymeric bonding agent, said thermoplastic polymer being present in a major portion and said polymeric bonding agent in a minor portion, said outer layer being bonded directly to said inner layer.

2. The layered tubing of claim 1, wherein said polyester has a melting point less than 260° C.

3. The layered tubing of claim 2, wherein said polyester has a melting point of about 245° C. and a density between 1.1 and 1.4 g/ml.

4. The layered tubing of claim 1, wherein said polyester is a copolyester comprising polyethyleneterephthlate and a 1,4-cyclohexanedimethanol/ethylene glycol/terephthalic acid copolymer, or polyethyleneterephthlate and a 1,4-cyclohexanedimethanol/ethylene glycol/1,4-benzenedicarboxylic acid dimethyl ester copolymer.

5. The layered tubing of claim 1, wherein said polyester has a water vapor transmission rate of less than 10 g/m² 24 h.

6. (canceled)

7. The layered tubing of claim 1, wherein the CO₂ permeability is less than 50 cm³·mm/m² 24 h·atm.

8. (canceled)

9. The layered tubing of claim 1, wherein the O₂ permeability is less than 10 cm³·mm/m² 24 h·atm.

10. (canceled)

11. The layered tubing of claim 1, wherein the CO₂ permeability is about 28 cm³·mm/m² 24 h·atm and the O₂ permeability is about 5.1 cm³·mm/m² 24 h·atm.

12. The layered tubing of claim 1, wherein said thermoplastic polymer is selected from the group consisting of polyethylene, polypropylene, ethylene vinyl acetate and polyvinyl chloride.

13-19. (canceled)

20. A layered beverage tubing comprising:
an inner layer having a fluid contacting surface, said inner layer consisting essentially of a PET polyester comprising repeat units of the formula C₁₀H₈O₄, said polyester having a CO₂ permeability of less than 100 cm³·mm/m² 24 h·atm and an O₂ permeability of less than 50 cm³·mm/m² 24 h·atm;
an outer layer disposed about said inner layer and comprising a thermoplastic polymer;
an intermediate layer composed of ethylene vinyl alcohol and disposed between said inner and outer layers;
a first bonding layer disposed between said inner and intermediate layers and comprising a first polymeric bonding agent bonding said inner and intermediate layers together; and
a second bonding layer disposed between said intermediate and outer layers and comprising a second polymeric bonding agent bonding said intermediate and outer layers together.

21. The layered tubing of claim 20, wherein said polyester has a melting point less than 260° C.

22. The layered tubing of claim 21, wherein said polyester has a melting point of about 245° C. and a density between 1.1 and 1.4 g/ml.

23. The layered tubing of claim 20, wherein said polyester is a copolyester comprising polyethyleneterephthlate and a 1,4-cyclohexanedimethanol/ethylene glycol/terephthalic acid copolymer, or polyethyleneterephthlate and a 1,4-cyclohexanedimethanol/ethylene glycol/1,4-benzenedicarboxylic acid dimethyl ester copolymer.

24. The layered tubing of claim 20, wherein said polyester has a water vapor transmission rate of less than 10 g/m² 24 h.

25. The layered tubing of claim 20, wherein the CO₂ permeability is less than 50 cm³·mm/m² 24 h·atm.

26. (canceled)

27. The layered tubing of claim 20, wherein the O₂ permeability is or less than 10 cm³·mm/m² 24 h·atm.

28. (canceled)

29. The layered tubing of claim 20, wherein the CO₂ permeability is about 28 cm³·mm/m² 24 h·atm and the O₂ permeability is about 5.1 cm³·mm/m² 24 h·atm.

30. (canceled)

31. The layered tubing of claim 20, wherein said first polymeric bonding agent is a bonding copolymer of ethylene and an oxygen-containing olefin.

32. (canceled)

33. The layered tubing of claim 20, wherein said thermoplastic polymer is selected from the group consisting of polyethylene, polypropylene, ethylene vinyl acetate and polyvinyl chloride.

34-38. (canceled)

39. A layered beverage tubing comprising:
an inner layer having a fluid contacting surface, said inner layer consisting essentially of a PET polyester comprising repeat units of the formula C₁₀H₈O₄, said polyester having a CO₂ permeability of less than 100 cm³·mm/m²·24 h·atm and an O₂ permeability of less than 50 cm³·mm/m²·24 h·atm;
an outer layer disposed about said inner layer and comprising a thermoplastic polymer; and
a bonding layer disposed between said inner and outer layers and comprising a polymeric bonding agent bonding said inner and outer layers together,
wherein the layered beverage tubing is adapted to convey a non-toxic beverage.

40. A layered beverage tubing comprising:
an inner layer having a fluid contacting surface, said inner layer consisting essentially of a PET polyester comprising repeat units of the formula C₁₀H₈O₄, said polyester having a CO₂ permeability of less than 100 cm³·mm/m2·24 h·atm and an O₂ permeability of less than 50 cm³·mm/m²·24 h·atm;
an outer layer disposed about said inner layer and comprising a blend of a thermoplastic polymer and a first polymeric bonding agent, said thermoplastic polymer being present in a major portion and said polymeric bonding agent in a minor portion;
an intermediate layer composed of ethylene vinyl alcohol and disposed between said inner and outer layers with said outer layer being bonded directly to said intermediate layer;
a bonding layer disposed between said inner and intermediate layers, the bonding layer comprising a second polymeric bonding agent bonding said inner and intermediate layers together,
wherein the layered beverage tubing is adapted to convey a non-toxic beverage.

41. The layered beverage tubing of claim 1, wherein the fluid contacting surface is readily and completely flushable, and washable with water for changing a beverage to various others having pungent flavor and taste.
